(19) United States
(12) Patent Application Publication
(10) Pub. No.: US 2011/0271213 A1
(43) Pub. Date: Nov. 3, 2011

(54) EVENT BASED SOCIAL NETWORKING APPLICATION

(75) Inventors: Hubert B. Newman, Kanata (CA); Quentin G. Garnier, Kanata (CA)

(73) Assignee: ALCATEL-LUCENT CANADA INC., Kanata (CA)

(21) Appl. No.: 13/093,878

(22) Filed: Apr. 26, 2011

Related U.S. Application Data
(60) Provisional application No. 61/330,648, filed on May 3, 2010.

(51) Int. Cl. G06F 3/048

(52) U.S. Cl. 715/758

(57) ABSTRACT

A method and apparatus are provided for event-based sharing of audio/video in real-time along with chat text by anyone capturing or viewing the shared video. An IMS-based server acts as a hub for the shared audio/video and chat text, which is then distributed to all participants. The chat text is conveyed in the data stream associated with the ISO transport stream carrying the audio and video streams. The audio and video streams and the chat text are recorded using a Network Digital Video Recorder, and can be viewed later by a user. During playback of a recorded event, the user can also switch between different recordings of the same event if available, as the IMS server maintains synchronization information for different recorded streams of the event. The method and apparatus provide improved social networking.

### FIELD OF THE INVENTION

This invention relates to social networking, and more particularly to sharing of event-based video transmissions.

### BACKGROUND OF THE INVENTION

Social networking software is very popular. However, current social networking software is limited in scope. Various existing methods of social networking are available, but they don't allow real-time sharing of video complete with chat text from others, nor do they allow a user to choose between video of the same event captured by multiple users.

### SUMMARY OF THE INVENTION

According to one aspect, the invention provides a method executed by an end user device. Video is captured on the end user device. The end user device sends the video to an IP Multimedia Subsystem (IMS) server as an ISO transport stream. The end user device receives chat text as input, and sends the chat text to the IMS server as part of the data stream of the ISO transport stream.

According to another aspect, the invention provides another method executed by an end user device. The end user device receives an ISO transport stream from an IP Multimedia Subsystem (IMS) server. Video from the ISO transport stream is displayed on the end user device, the video having been captured by another end user device.

According to yet another aspect, the invention provides yet another method executed by an end user device. The end user device receives from an IP Multimedia Subsystem (IMS) server a list of at least one recorded event. The end user device receives as input a selection of one of the at least one recorded event. The end user device sends the selection to the IMS server, and receives from the IMS server an ISO transport stream associated with the selection.

According to yet another aspect, the invention provides a method executed by an IP Multimedia Subsystem (IMS) server. Login information from an end user device is received. An indication is received from the end user device that an event is to be created and the event is created. An ISO transport stream is received from the end user device, and the ISO stream is forwarded to at least one other end user device, the at least one other end user device being in a distribution list associated with the event.

According to yet another aspect, the invention provides another method executed by an IP Multimedia Subsystem (IMS) server. An ISO transport stream is received from a first end user device. The ISO transport stream is forwarded to a Network Digital Video Recorder for recording. A list of at least one recorded event available for playback, including an event with which the ISO transport stream is associated, is sent to a second end user device. A selection of one of the at least one recorded event for playback is received from the second end user device. An ISO transport stream for the selected event is retrieved, and transmitted to the second end user device.

The methods of the invention may be stored as processing instructions on non-transitory computer-readable storage media, the instructions being executable by a computer processor.

The invention allows the real-time sharing of events. One user can capture audio and/or video of the event and share it with others in real-time, and that user or anyone watching the captured event can share chat text while watching the captured event. Different end user devices, such as cell phones, wireless or wireline personal computers, or tru2way™ TVs and set top boxes have different abilities, ranging from capturing an event, providing chat text, or simply viewing the captured event, and these are provided for. The invention is also IMS-based, which allows the invention to be more easily scaled to large numbers of users. The invention also allows recordal of an event with different people recording different perspectives of the event, along with recordal of chat text made during watching of the event in real-time. The invention allows such recordings to be played back, and the IMS-server maintains synchronization information of different audio/video and chat streams of the event, allowing a viewer of the recorded event to switch between different recordings of the event.

### BRIEF DESCRIPTION OF THE DRAWINGS

The features and advantages of the invention will become more apparent from the following detailed description of the preferred embodiment(s) with reference to the attached figures, wherein:

FIG. 1 is a diagram of a portion of a network according to one embodiment of the invention;

FIG. 2 is a flowchart of a method carried out by an end user device of FIG. 1 according to one embodiment of the invention;

FIG. 3 is a flowchart of another method carried out by an end user device according to one embodiment of the invention;

FIG. 4 is a flowchart of another method carried out by an end user device according to one embodiment of the invention;

FIG. 5 is a flowchart of another method carried out by an end user device according to one embodiment of the invention;

FIG. 6 is a flowchart of a method carried out by the IMS server of FIG. 1 according to one embodiment of the invention;

FIG. 7 is a flowchart of another method carried out by the IMS server according to one embodiment of the invention;

FIG. 8 is a flowchart of another method carried out by the IMS server according to one embodiment of the invention;

FIG. 9 is a flowchart of another method carried out by the IMS server according to one embodiment of the invention; and

FIG. 10 is a flowchart of another method carried out by the IMS server according to one embodiment of the invention.

It is noted that in the attached figures, like features bear similar labels.

### DETAILED DESCRIPTION OF THE PREFERRED EMBODIMENTS

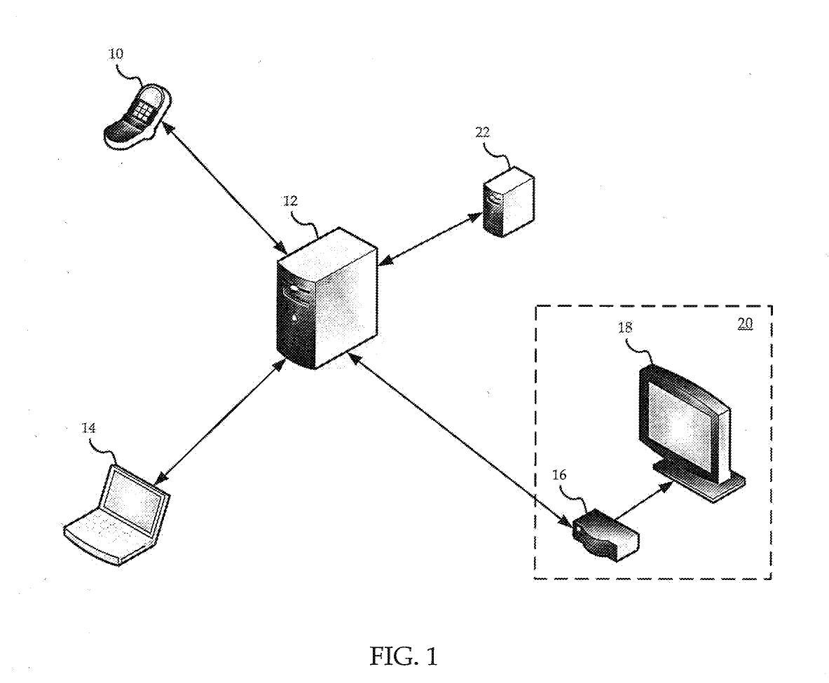

Referring to FIG. 1, a diagram of a portion of a network according to one embodiment of the invention is shown. A cell phone 10 is connected to an IMS (IP Multimedia Subsystem) based server 12. The cell phone 10 is of the type that has the ability to capture audio and/or video. The IMS server 12 is also in communication with a personal computer (PC) 14, which may either be a wireless PC or a desktop PC. The IMS server 12 is also connected to a set top box (STB) 16, and the STB displays signals on a television (TV) 18. The STB 16 and the TV 18 together can be considered an STB/TV set 20. The IMS server 12 is also connected to a Network Digital Video Recorder 22. Collectively, the cell phone 10, the PC 14, and the STB/TV set 20 are termed end user devices.

There may alternatively be no STB 16 if the TV 18 is able to communicate directly to the IMS server 12, such as if the TV 18 is a digital TV and supports tru2way™, in which case the TV itself is an end user device. The network shown in FIG. 1 is for example purposes only, and more generally there will be zero or more STB/TV sets, zero or more digital TVs, zero or more PCs, and zero or more cell phones, but with at least two end user devices, one of which has the ability to capture audio and/or video.

The cell phone 10 has the ability to capture audio/video, to display audio/video, to display chat text, and to allow text to be entered. The PC 14 has the ability to display audio/video, to display chat text, and to allow text to be entered. The STB/TV set 20 has the ability to display audio/video and to display chat text. It should be noted that the abilities of each of the end user devices are for illustration purposes only. Another cell phone may also be connected to the IMS server 12 and form part of the network described herein, yet be unable to capture audio or video. As another example, another PC may be connected to the IMS server 12 and form part of the network described herein, and be able to capture audio/video such by use of a webcam. However, for the purposes of distinguishing various applications located on end user devices, the cell phone 10, the PC 14, and the STB/TV set 20, each with their respective abilities as described above, will be used when describing the invention.

The IMS server 12 is based on IMS. In other words, the interfaces to the end user devices and to the Network Digital Video Recorder 22 are compliant with the IMS architecture. Messages exchanged between the end user devices and the IMS server 12 are compliant with the format specified by the IMS architecture.

The end user devices each include an application. These applications depend on the abilities of the end user device on which the application runs. Alternatively, each end user device has the same application but only some portions of the application are made available or selectable based on the abilities of the end user device. The functionality of these applications is described below. The IMS server 12 also includes an application, with the functionality described below.

Broadly, the invention allows an end user device to generate an event or to join an existing event generated by another end user device. If the end user device generates an event, then audio/video captured by the end user device is sent to the IMS server 12, which passes audio/video signals to all other end user devices which have joined the event. If the end user device also has the ability to allow text to be entered, then the end user device sends chat text entered at the end user device to the IMS server 12 as part of the data stream of an ISO transport stream, and the IMS server 12 then forwards the chat text to all end user devices taking part in the event as part of the data stream of the ISO transport stream conveying the captured video and audio of the event, where the text is displayed.

If the end user device joins an existing event, then the audio/video signals for the event and forwarded to the end user device by the IMS server 12 are displayed on the end user device. If the end user device has the ability to capture content, such as by allowing text to be entered, then the end user device sends such content to the IMS server 12 as part of the data stream of an ISO transport stream, and the IMS server 12 then forwards the content to all end user devices taking part in the event as part of the data stream of the ISO transport stream conveying the captured video and audio of the event, where the content is made available such as by displaying chat text.

In one embodiment, the IMS server 12 sends all streams related to the event to a Network Digital Video Recorder 22, including chat text, where they are stored. The IMS server 12 stores synchronization information of the streams, and when an event is recalled later for playback by an end user device, the IMS server 12 refers to the stored synchronization information for the event in order to retrieve different streams from the Network Digital Video Recorder 22 and make the correct streams available to the end user device at the correct playback time.

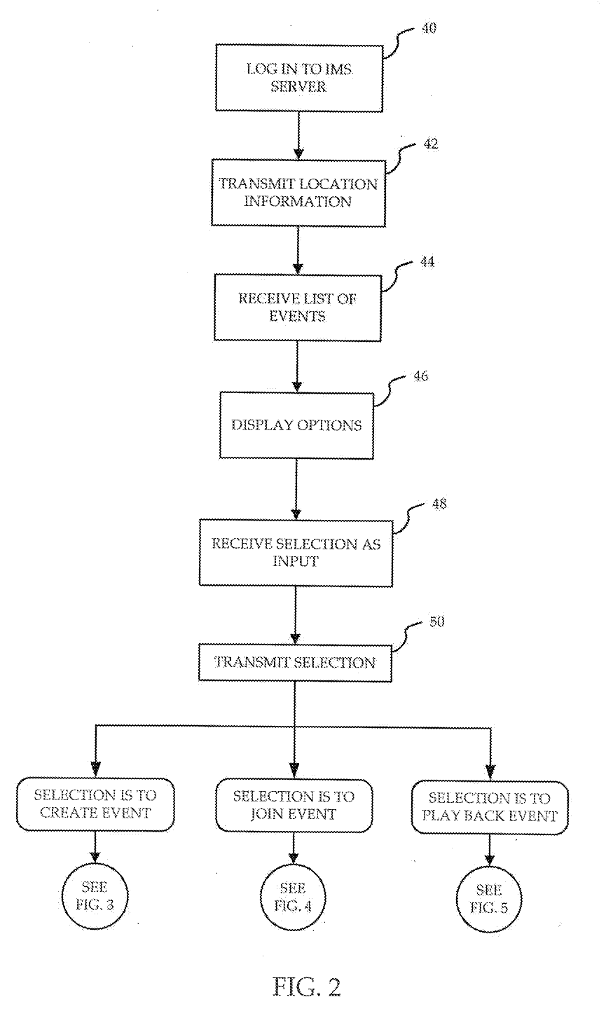

The cell phone 10 contains an application for creating events, viewing live events, and playing back recorded events. These may alternatively be parts of more than one application, for example a separate application for playing back recorded events, but they will be described herein as components of a single application for the purposes of simplicity. As stated above, this method is applicable to any end user device with the ability to capture audio/video signals, but for the purposes of illustration is described with reference to the cell phone 10 of FIG. 1. Referring to FIG. 2, a flowchart of a method carried out by the application according to one embodiment of the invention is shown. At step 40 the cell phone 10 starts a session with the IMS server 12. Since the IMS server 12 is IMS-based, the cell phone 10 starts the session by exchanging SIP messages with the IMS server 12.

In one embodiment, at step 42 the cell phone 10 then sends to the IMS server 12 location information identifying the location of the cell phone 10. Values identifying the location of the cell phone 10 are sent automatically by the inherent abilities of the cell phone 10. This is also referred to as “geotagging” of the cell phone 10.

At step 44 the cell phone 10 receives a list of events from the IMS server 12. This list of events may be empty, or the cell phone may instead receive an indication that no list of events is being sent, such as if the cell phone 10 is not on a contact list of any existing events. The list of events may also include an indication for at least one event that the event is nearby, as indicated by location information received at login of the end user device which created the event and location information received at login of the cell phone 10.

At step 46 the cell phone presents a set of options on the display of the cell phone. These options include an option to create an event, to join an existing event, or to playback a recorded event. If the list of events sent at step 44 includes an event whose location is similar to that of the cell phone 10 as indicated by the geotagging of the cell phone 10, then the existence of an already existing nearby event is indicated near the presentation of the option to create an event. This may cause the user of the cell phone to join the already existing nearby event. If no list of events has been sent or if the list of events is empty then an indication that there are no existing events to join is displayed. At step 48 the cell phone 10 accepts as input a selection of one of the options.

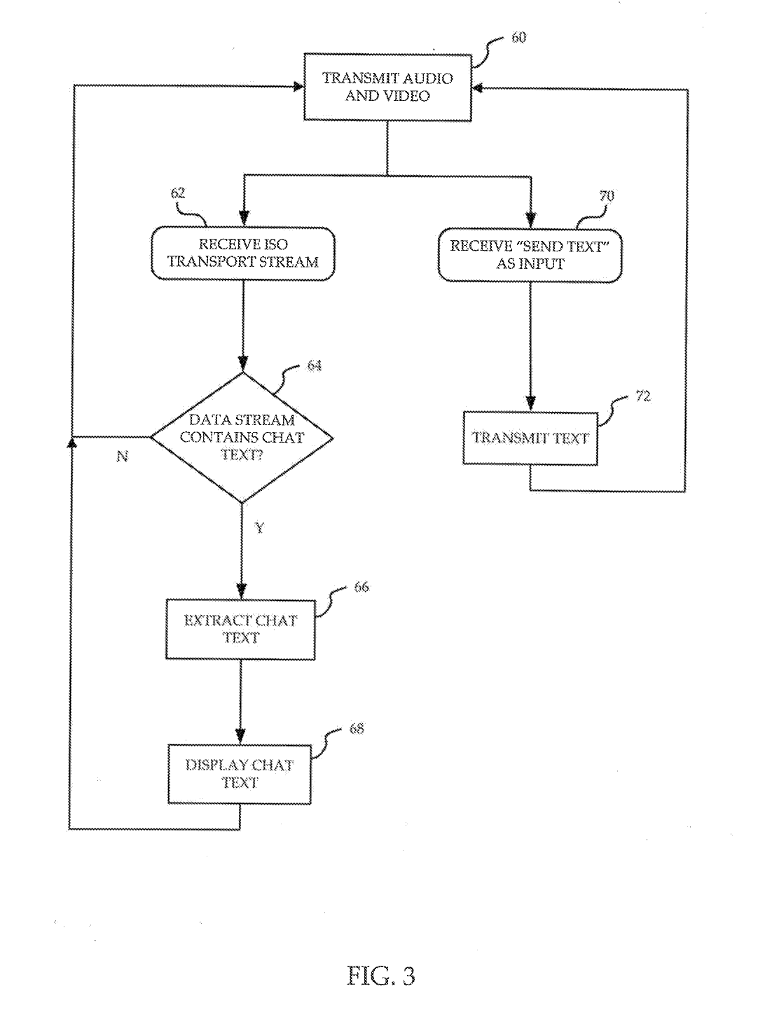

At step 50 the cell phone 10 transmits the selection to the IMS server 12. It should be noted however that other options may be entered at this or at any other time, such as the option to quit the application, but these will not be described herein. Depending on the selection entered as input different methods, as described below with reference to FIG. 3 to FIG. 5, will be performed.

Referring to FIG. 3, a flowchart of a method by which the cell phone creates an event according to one embodiment of the invention is shown. This method will normally be executed when a user selects to create an event, as described above with reference to step 48 of FIG. 2. At step 60 the cell phone 10 transmits to the IMS server 12 video and/or audio that is captured by the cell phone 10. Any video captured by the cell phone 10 is sent as packets within the video stream of an ISO transport stream, and any audio captured by the cell phone 10 is sent as packets within the audio stream of the ISO transport stream. The video and/or audio captured by the cell phone 10 are also displayed directly on the display of the cell phone.

At any time during transmission of an ISO transport stream for the event generated by the cell phone 10, the cell phone 10 may receive packets for another ISO transport streams from the IMS server 12. Upon receipt of packets in an ISO transport stream from the IMS server 12 at step 62, the cell phone 10 examines the data stream of such an ISO transport stream at step 64 and determines if it contains chat text. The cell phone 10 does this by examining the header information of the packets in the data stream to see if the packets identify their data as of the type “private sections”. If so, then at step 66 the cell phone 10 extracts any chat text from packets in the data stream of the ISO transport stream, and displays the chat text on the display of the cell phone 10 at step 68. The chat text may be displayed in any manner, one example of which is displaying the chat text for 5 seconds near the bottom of the video display of the event. The cell phone 10 also displays an indication of the originator of the chat text, the originator also being contained in header information of the packets containing the chat text, such as in a colour specific to the originator and/or a name or nickname associated with the originator.

At any time during transmission of an ISO transport stream for the event generated by the cell phone 10, the cell phone 10 may receive chat text as input. This will usually occur when the user capturing the event chooses to add chat text which may be of interest to others watching the event remotely on their own end user devices. At step 70 the cell phone 10 receives an indication that chat text is to be sent. At step 72 the cell phone 10 embeds the chat text in the data stream of the ISO transport stream that is being sent to the IMS server 12, along with an identification of the end user device 10, such as a username of the user who entered the chat text.

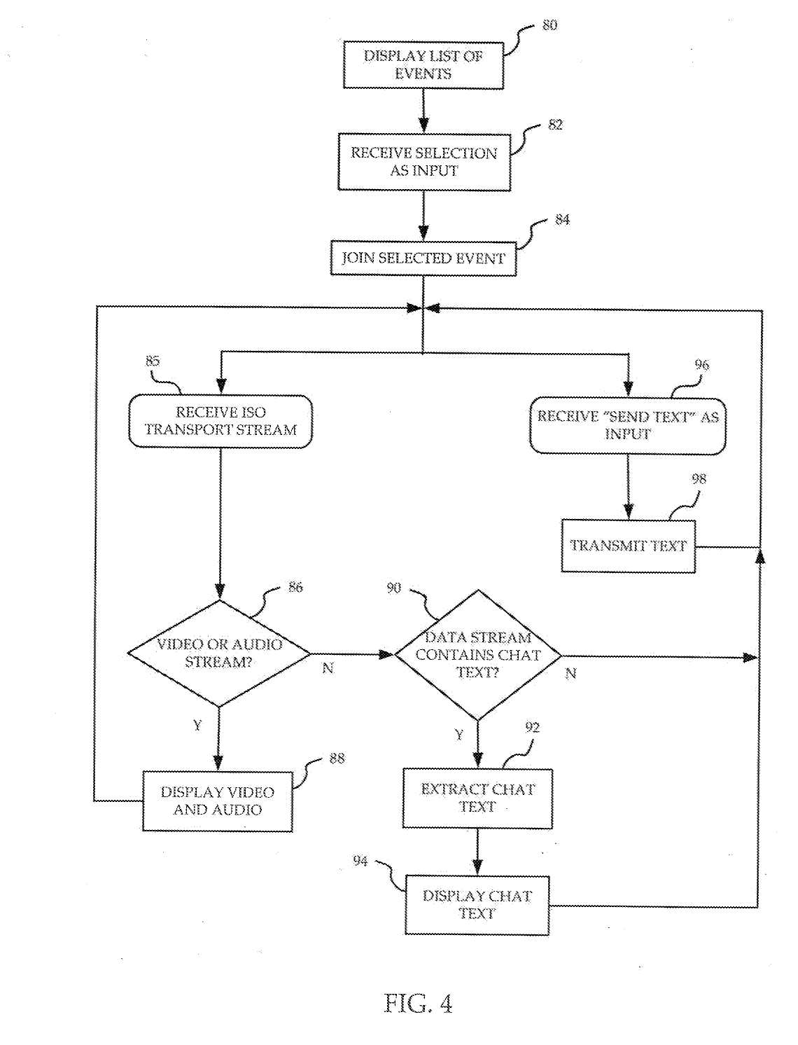

Referring to FIG. 4, a flowchart of a method by which the cell phone 10 joins an existing event according to one embodiment of the invention is shown. This method will normally be executed when a user selects to join an existing event, as described above with reference to step 48 of FIG. 2. At step 80 the cell phone 10 displays a list of the events which can be joined, as indicated by the list of events received at step 44. At step 82 the cell phone 10 receives as input a selection of one of the listed events. At step 84 the cell phone 10 joins the event indicated by the input selection by sending a message to the IMS server 12 indicating that the cell phone 10 is to join the selected event.

Thereafter, the cell phone 10 may receive packets forming an ISO transport stream at step 85 from the IMS server 12 related to that event. At step 86 the cell phone 10 examines packets received as part of the ISO transport stream. If the packets are part of the video or audio streams of the ISO transport stream, then they are displayed using the display capabilities of the cell phone 10 at step 88. The audio and/or video will usually have been captured by another end user device. If they are instead part of the data stream of the ISO transport stream, then at step 90 the cell phone 10 determines if the packets contain chat text as indicated by the header information of the packets. If the packets contain chat text, then at step 92 the chat text is extracted from the packets and at step 94 the extracted chat text is displayed on the display of the cell phone 10. The chat text may be displayed in any manner, one example of which is displaying the chat text for 5 seconds. The cell phone 10 also displays an indication of the originator of the chat text, the originator being contained in header information of the packets containing the chat text, such as in a colour specific to the originator and/or a name or nickname associated with the originator.

At any time during reception of the ISO transport stream for an event which has been joined by the cell phone 10, the cell phone 10 may receive content as input, such as chat text. If at step 96 the cell phone 10 receives an indication that chat text is to be sent, then the cell phone 10 generates another ISO transport stream in which any chat text entered as input on the cell phone 10 is placed in the data stream of the ISO transport stream. The cell phone 10 then sends this other ISO transport stream to the IMS server 12 at step 98. Other types of content are also sent to the IMS server 12 in an ISO transport stream.

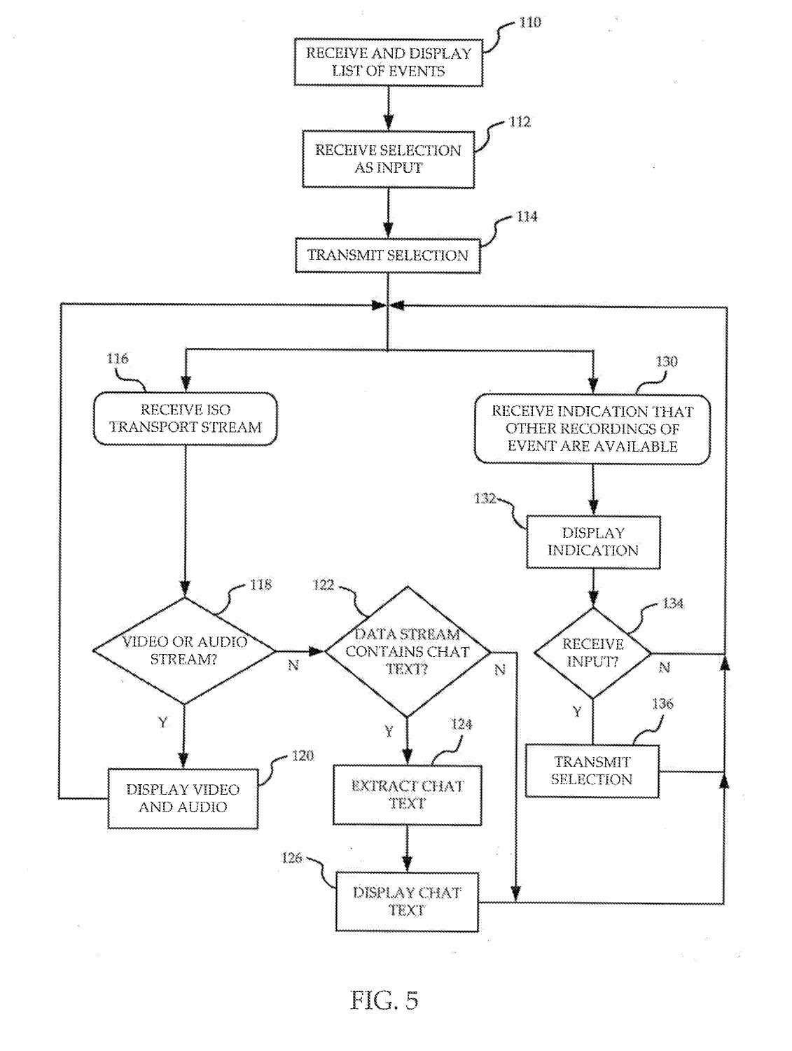

Referring to FIG. 5, a flowchart of a method by which the cell phone 10 plays back a recorded existing event according to one embodiment of the invention is shown. This method will normally be executed when a user selects to play back a recorded event, as described above with reference to step 48 of FIG. 2. At step 110 a list of at least one recorded event available for playback by the cell phone 10 is received by the cell phone 10 from the IMS server 12 and displayed. An indication of the types of events to be included in the list sent from the IMS server 12 to the cell phone may optionally be sent beforehand from the cell phone 10. For example, a user may enter into the cell phone 10 the name of a concert or the identity of a person who has recorded events, and the cell phone 10 then transmits such to the IMS server 12 in order that a more manageable list of available events be sent by the IMS server 12. At step 112 the cell phone 10 receives as input a selection of one of the events in the received list, and at step 114 the cell phone 10 sends the selection to the IMS server 12.

The cell phone 10 thereafter begins receiving at step 116 packets in an ISO transport stream associated with the selected event from the IMS server 12. If the cell phone determines at step 118 that the packets are part of an audio or video stream, then at step 120 the cell phone 10 displays the contents of the video stream or audio stream.

During display of the video and audio streams of the ISO transport stream, the cell phone may receive additional streams representing chat text that was generated at the time of recordal of the event and was recorded. If the cell phone 10 determines at step 118 that the received packets are part of a data stream, then at step 122 the cell phone 10 determines whether the received packets contain chat text by examining the header of the packets. If so, then at step 124 the cell phone 10 extracts the chat text, and displays it at step 126. The chat text may be displayed in any manner, one example of which is displaying the chat text for 5 seconds near the bottom of the video display of the event. The cell phone 10 also displays an indication of the originator of the chat text, the originator being contained in header information of the packets containing the chat text, such as in a colour specific to the originator and/or a name or nickname associated with the originator.

During display of the video and audio streams of the ISO transport stream, the cell phone 10 may receive from the IMS server 12 at step 130 indications that other recordings of the event have become available. Since the IMS server 12 is IMS-based, such indications will be IMS compatible messages. Other recordings of the event will generally become available if synchronization information stored on the IMS server 12 indicates that other recordings are stored on the Network Digital Video Recorder 22, as described below. At step 132 the cell phone 10 displays a selectable indication that the other recording of the event is available. The cell phone 10 will only display such indications for as long as the other recordings are available in the time frame of the recording currently being displayed. In other words, a user of the cell phone 10 can select to view different recordings of the same event as the recording of the event unfolds. At step 134 the cell phone 10 may receive as input an indication that the other available recording of the event is to be displayed. If so, then at step 136 the cell phone 10 sends an indication of the alternate recording of the event to the IMS server 12. From then on, or very shortly thereafter, the video and audio streams received by the cell phone 10 will be those in an ISO transport stream corresponding to the selected recording of the event.

Much of the functionality of the application on the cell phone 10 is carried out in response to input from a user of the cell phone 10. As such, a user interface which allows the user to interact with the application described with reference to FIG. 2 to FIG. 5 is provided. The user interface includes, for example, means to enter chat text, icons to select an existing event to join, and icons navigating among the various selection options.

Similar applications to that described above with reference to FIG. 2 to FIG. 5 run on the PC 14 and on the STB/TV set 20. However, in the case of the PC 14, the ability to capture audio or video is not present. Accordingly the ability to create a new event, described above with reference to FIG. 3, is either not present or is not selectable.

The STB/TV set 20 also lacks the ability to capture audio or video, and so the option to create a new event is either not present or is not selectable. In addition, the STB/TV set 20 lacks the ability to receive chat text as input.

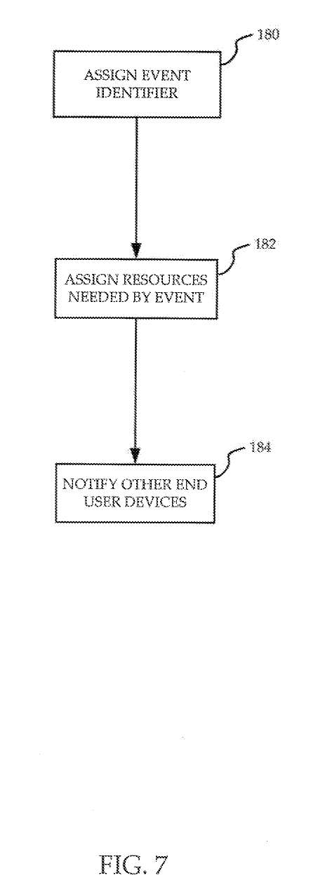

At any time while the end user device is logged into the IMS server 12, the end user device may receive notifications of new events created by another user in whom the user of the end user device has expressed interest. Such notifications are distributed by the IMS server 12, as described below with reference to step 184 of FIG. 7.

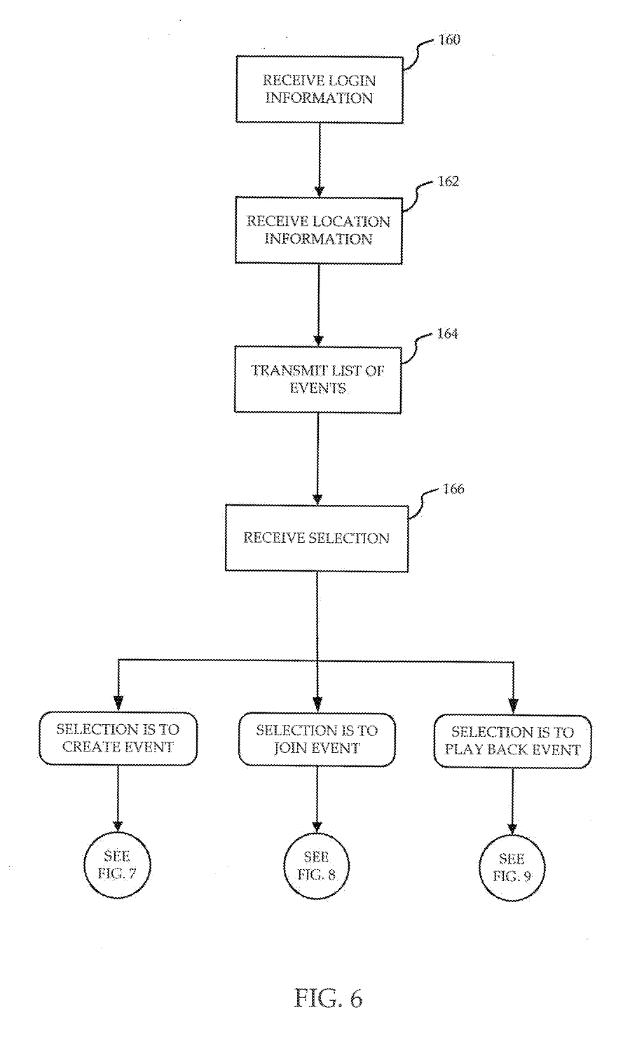

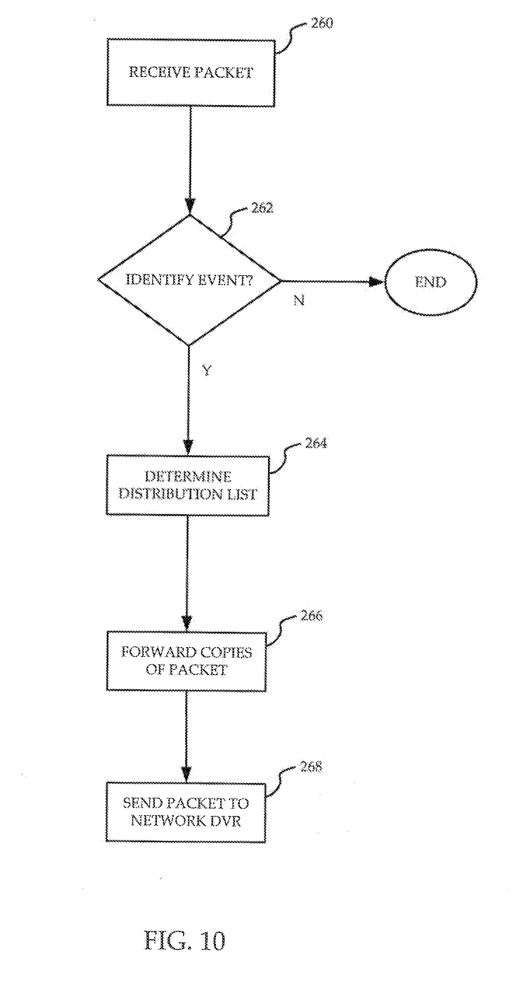

Two occurrences that can trigger action by the IMS server 12 are receipt of packets belonging to an ISO transport stream, described below with respect to FIG. 10, and receipt of login information from an end user device. Referring to FIG. 6, a flowchart of a method executed by an application on the IMS server 12 according to one embodiment of the invention is shown. The method is triggered at step 160 when the IMS server 12 receives login information from an end user device. At step 162 the IMS server 12 may receive location information about the end user device which is starting the session. At step 164 the IMS server 12 sends a list of nearby events as determined from the location information received at step 162, although if no similar events are found to already exist then either the list will be empty or an indication that there are no such events is sent.

At step 166 the IMS server 12 receives a choice from the end user device. This is the same choice that should have been sent by the end user device as described above with reference to step 50 of FIG. 2. The subsequent method depends on if the choice received from the end user device is to create a new event, to join an existing event, or to play back an event.

Referring to FIG. 7 a flowchart of a method by which the application on the IMS server 12 creates a new event according to one embodiment of the invention is shown. The method is executed when the IMS server 12 receives from the end user device an indication that a new event is to be created, as described above with reference to step 166 of FIG. 6. At step 180 the IMS server 12 assigns an event identification to the newly created event. At step 182 the IMS server 12 assigns other resources required to create and monitor an event, such as the creation of an event object.

At step 184 the IMS server 12 notifies at least one other end user device about the newly created event, at which point the other end user devices may join the event if they wish. The IMS server 12 knows which other end user devices to notify by consulting information stored at the IMS server 12 about end user devices. End user devices which have previously expressed interest in new events by the end user device generating the event are identified. Alternatively, or depending on configuration choices of the user creating the event, end user devices which have been indicated as allowed by the user of the end user device generating the event are identified.

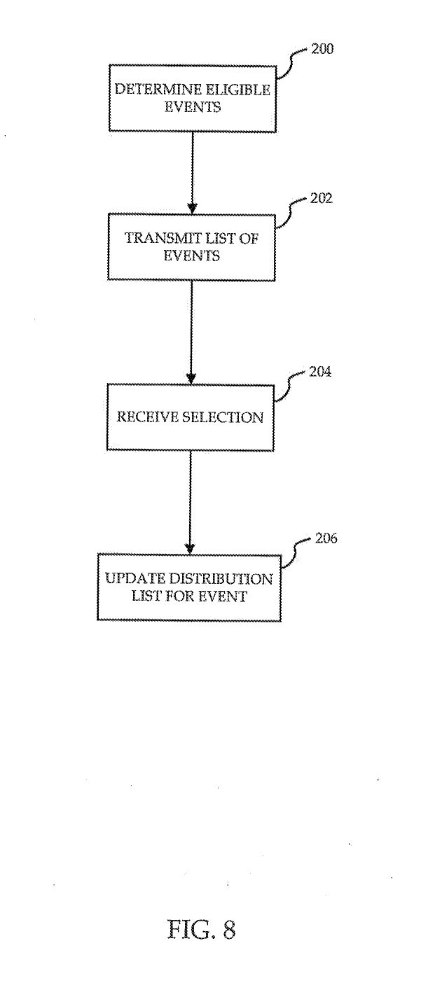

Referring to FIG. 8 a flowchart of a method by which the application on the IMS server 12 joins an end user device to an existing event according to one embodiment of the invention is shown. The method is executed when the IMS server 12 receives from the end user device the choice to join an existing event, as described above with reference to step 166 of FIG. 6. At step 200 the IMS server 12 determines which events are eligible to be joined. This can be determined in any of a number of ways, such as those events generated by people who have the joining end user device in a contact list. At step 202 the IMS server 12 sends the list of eligible events to the end user device. At step 204 the IMS server 12 receives from the end user device a selection of an event. This selection is the same selection that should have been sent by the end user device as described above with reference to step 84 of FIG. 4.

At step 206 the IMS server 12 adds the end user device to the event by updating a distribution list associated with the event defined by the selection received at step 204 with the identity of the end user device received at step 160. Thereafter, the end user device which joined the event receives packets from the ISM server for that event, as described below with reference to FIG. 10.

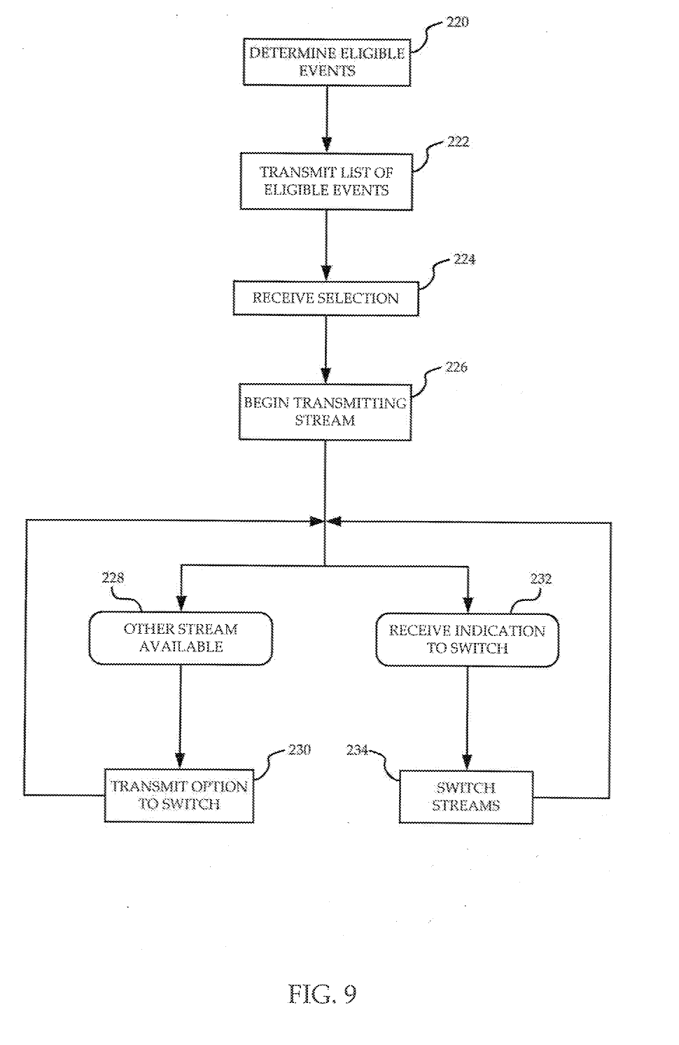

Referring to FIG. 9 a flowchart of a method by which the application on the IMS server 12 presents a recorded event to an end user device according to one embodiment of the invention is shown. The method is executed when the IMS server 12 receives from the end user device the choice to play back a recorded event, as described above with reference to step 166 of FIG. 6. At step 220 the IMS server 12 determines which recorded events are available for play back. This determination can be made in any way, such as events created by people who have the end user device on their contact list, making all events available, or limiting the events to some criteria sent by the end user device. At step 222 the IMS server 12 sends the list of eligible events to the end user device. At step 224 the IMS server 12 receives a selection from the end user device, the selection identifying one of the eligible events. At step 226 the IMS server 12 retrieves an ISO transport stream for the recorded event from the Network Digital Video Recorder 22 and begins transmitting the event to the end user device as an ISO transport stream. The event will have been recorded in the Network Digital Video Recorder 22 as described below with reference to FIG. 10. The ISO transport stream includes any chat text in its data stream that was also recorded as part of the stream previously recorded by the Network Digital Video Recorder 22.

During transmission of the ISO transmission stream, the IMS server 12 may determine that another audio/video recording for the event is available. Another audio/video recording for the event may exist, for example, if a user which had joined the event also captured audio and/or video relating to the event, thereby providing a different perspective. At step 228 the IMS server 12 determines that another recording for the event is available. The IMS server 12 determines this from synchronization information stored at the IMS server 12, which is stores for all ISO transport streams forwarded to the Network Digital Video Recorder. The synchronization information includes an identification of the event, along with start and end times of other recorded audio and/or video streams for the event relative to the start time of the main stream, and an identification of those recorded streams. At step 230 the IMS server 12 sends an indication of the availability of the other recording to the end user device.

The IMS server 12 may also receive from the end user device an indication that the other recording is to be viewed, i.e. to switch audio/video streams. At step 232 the IMS server 12 receives such an indication. At step 234 the IMS server 12 switches the ISO transport stream that is being sent to the end user device. The IMS server 12 does this by retrieving the new stream containing the other recording from the Network Digital Video Recorder 22 if it has not already been retrieved, and begins sending the new stream as the ISO transport stream to the end user device.

The second type of event that can trigger an action by the IMS server 12 is receipt of a packet belonging to an event. Referring to FIG. 10 a flowchart of a method by which the application on the IMS server 12 reacts to receipt of a packet identifying an event according to one embodiment of the invention is shown. At step 260 the IMS server 12 receives a packet from an end user device which has started a session with the IMS server 12, as described above with reference to step 40 of FIG. 2. At step 262 the IMS server 12 attempts to identify an event associated with the received packet. If the IMS server 12 cannot identify an event for the packet, then the IMS server 12 stops processing the packet, or processes the packet using some other process, such as an error handling procedure. Otherwise, at step 264 the IMS server 12 determines a distribution list for the event associated with the packet. The distribution list is an identification of end user devices which are viewing the event by having joined the event, as described above with reference to step 84 of FIG. 4. At step 266 the IMS server 12 forwards copies of the packet to the end user devices identified in the distribution list.

At step 268 the IMS server 12 sends a copy of the packet to the Network Digital Video Recorder 22 as part of the ISO transport stream sent to the Network Digital Video Recorder 22, where it is recorded.

The applications on the end user devices and on the IMS software are preferably implemented as logical instructions in the form of software. Alternatively, each or all of the logical instructions may be implemented as hardware, or as a combination of software or hardware. If in the form of software, the logical instructions may be stored on non-transitory computer-readable storage media in a form executable by a computer processor.

The invention has been described as recording streams related to an event and allowing later play back of the recorded streams. This is an optional feature, and the invention provides enhanced social networking capabilities even without this feature.

The embodiments presented are exemplary only and persons skilled in the art would appreciate that variations to the embodiments described above may be made without departing from the spirit of the invention. Methods which are logically equivalent to the methods described above may be used. The scope of the invention is solely defined by the appended claims.

I/we claim:

1. A method executed by an end user device, comprising:
capturing video on the end user device;
sending by the end user device the video to an IP Multimedia Subsystem (IMS) server as an ISO transport stream;
receiving chat text on the end user device as input; and
sending by the end user device the chat text to the IMS server as part of the data stream of the ISO transport stream.

2. The method of claim 1 further comprising:
receiving at the end user device another ISO stream from the IMS server;
extracting by the end user device any chat text from the data stream of the other ISO stream; and
displaying on the end user device any chat text extracted from the other ISO stream.

3. The method of claim 2 wherein displaying on the end user device any chat text extracted from the other ISO stream comprises displaying an indication of the originator of such chat text.

4. A method executed by an end user device, comprising:
receiving at the end user device an ISO transport stream from an IP Multimedia Subsystem (IMS) server;
displaying on the end user device video from the ISO transport stream, the video having been captured by another end user device.

5. The method of claim 4 further comprising:
receiving content on the end user device; and
sending by the end user device the content to the IMS server.

6. The method of claim 4 wherein receiving content on the end user device comprises receiving chat text on an input of the end user device, and wherein sending by the end user device the content to the IMS server comprises sending by the end user device the chat text to the IMS server as part of the data stream of another ISO transport stream.

7. The method of claim 4 wherein receiving content on the end user device comprises capturing video by the end user device, and wherein sending by the end user device the content to the IMS server comprises sending by the end user device the captured video as another ISO transport stream.

8. The method of claim 4 further comprising:
receiving at the end user device from the IMS server a list of at least one event; and
sending by the end user device to the IMS server a selection of one of the at least one event in the list.

9. The method of claim 8 further comprising:
sending by the end user device to the IMS server location information identifying the location of the end user device,
and wherein the list of at least one event includes an indication that at least one event in the list is near the end user device.

10. A method executed by an end user device, comprising:
receiving at the end user device from an IP Multimedia Subsystem (IMS) server a list of at least one recorded event;
receiving at the end user device as input a selection of one of the at least one recorded event;
sending the selection from the end user device to the IMS server; and
receiving at the end user device from the IMS server an ISO transport stream associated with the selection.

11. The method of claim 10 further comprising:
sending from the end user device to the IMS server an indication of a type of event,
and wherein each of the at least one recorded event in the list is of the type indicated by the end user device.

12. The method of claim 10 further comprising:
during receiving an ISO transport stream at the end user device, receiving by the end user device from the IMS server an indication that another recording associated with the event is available;
receiving at the end user device as input an indication that the other recording is to be displayed on the end user device; and
sending the indication from the end user device to the IMS server.

13. A method executed by an IP Multimedia Subsystem (IMS) server, comprising:
receiving login information from an end user device;
receiving an indication from the end user device that an event is to be created;
creating the event;
receiving an ISO transport stream from the end user device; and
forwarding the ISO stream to at least one other end user device, the at least one other end user device being in a distribution list associated with the event.

14. The method of claim 13 further comprising:
notifying at least one yet other end user device that the event has been created.

15. The method of claim 13 further comprising:
receiving login information from a yet further end user device;
sending a list of available events to the yet further end user device;
receiving a selection of an event to join from the yet further end user device; and
adding the yet further end user device to the distribution list associated with the event indicated by the selection.

16. The method of claim 15 wherein receiving login information from the end user device comprises receiving location information associated with the end user device, wherein receiving login information from the yet further end user device comprises receiving location information associated with the yet further end user device, and wherein if the location information associated with the end user device and the location information associated with the yet further end user device indicate that the yet further end user device is nearby to the end user device then sending an indication to the yet further end user device that the event generated by the end user device is a nearby event.

17. The method of claim 13 further comprising:
forwarding the ISO transport stream to a Network Digital Video Recorder for recording.

18. A method executed by an IP Multimedia Subsystem (IMS) server, comprising:
receiving an ISO transport stream from a first end user device;
forwarding the ISO transport stream to a Network Digital Video Recorder for recording;
sending to a second end user device a list of at least one recorded event available for playback, including an event with which the ISO transport stream is associated;
receiving from the second end user device a selection of one of the at least one recorded event for playback;
retrieving an ISO transport stream for the selected event; and
transmitting the ISO transport stream associated with the selected event to the second end user device.

19. The method of claim 18 wherein the ISO transport stream includes chat text within a data stream.

20. The method of claim 18 further comprising:
storing synchronization information for all ISO transport streams forwarded to the Network Digital Video Recorder;
when the synchronization information indicates that a second recording for the selected event is available, sending an indication to the second end user device that the second recording is available; and
if the IMS server receives from the second end user device an indication that the second recording is to be viewed, sending a second ISO transport stream containing the second recording to the second end user device.
